(19) United States
(12) Patent Application Publication
(10) Pub. No.: US 2023/0056931 A1
(43) Pub. Date: Feb. 23, 2023

(54) BATTERY PACK FIXING SYSTEM, AND MOUNTING METHOD AND DISMOUNTING METHOD FOR BATTERY PACK

(71) Applicants: AULTON NEW ENERGY AUTOMOTIVE TECHNOLOGY GROUP, Guangzhou, Guangdong (CN); SHANGHAI DIANBA NEW ENERGY TECHNOLOGY CO., LTD., Shanghai (CN)

(72) Inventors: Jianping Zhang, Shanghai (CN); Danliang Qiu, Shanghai (CN); Zhibo Lan, Shanghai (CN)

(21) Appl. No.: 17/794,690

(22) PCT Filed: Jan. 25, 2021
(86) PCT No.: PCT/CN2021/073583

§ 371 Date: Jul. 22, 2022

(30) Foreign Application Priority Data
Jan. 23, 2020 (CN) 202010076987.0
Jan. 23, 2020 (CN) 202010076997.4

(51) Int. Cl. H01M 50/244; H01M 50/249; B60K 1/04

(52) U.S. Cl. CPC H01M 50/244; H01M 50/249; B60K 1/04; H01M 2220/20

(57) ABSTRACT

Disclosed is a battery pack fixing system. The battery pack fixing system comprises a locking mechanism (1), wherein the locking mechanism (1) is arranged on the contact surface of a battery pack (2) and a support (3), and the battery pack (2) is unlocked or locked on the support (3) by rotating the locking mechanism (1). According to the battery pack fixing system, the battery pack (2) is unlocked or locked on the support (3) by using the rotation movement of the locking mechanism (1) in different directions, so that the objective of fixing the battery pack (2) on the support (3) is achieved; and compared with a traditional locking mechanism, the battery pack fixing system has advantages such as being firmer in fixing and highly reliable. Further disclosed are a mounting method and a dismounting method for the battery pack.

This application claims the priority of Chinese patent applications 202010076997.4 and 202010076987.0 filed on Jan. 23, 2020. This application refers to the full text of the above-mentioned Chinese patent application.

### TECHNICAL FIELD

The present invention relates to the field of battery replacement, in particular to a battery pack fixing system, and an installation method and a removal method of the battery pack.

### TECHNICAL BACKGROUND

In the prior art, the fixing of the battery pack on the bracket is usually realized by a locking mechanism provided on the bracket, and the locking block on the locking mechanism realizes the locking of the battery pack by means of horizontal displacement, so that the fixing firmness of the battery pack is poor, and it is easy to lock the position of the battery pack when the battery pack is not in place, resulting in the electrical connector between the battery pack and the bracket being not properly connected, which affects the normal use of the vehicle.

### SUMMARY OF THE INVENTION

The technical problem to be solved by the present invention is to provide a battery pack fixing system, an installation method and a removal method of the battery pack in order to overcome the defect of poor fixing firmness of the locking mechanism for locking the position of the battery pack in the prior art.

The present invention solves the above-mentioned technical problems through the following technical solutions:

A battery pack fixing system, comprising a locking mechanism, the locking mechanism is arranged on contact surfaces of the battery pack and a bracket, and the battery pack is unlocked from or locked on the bracket by rotating the locking mechanism on the bracket.

The battery pack fixing system unlocks or locks the battery pack on the bracket by using the rotation action of the locking mechanism in different directions, so as to achieve the purpose of fixing the battery pack on the bracket, and has the advantages of firmer fixing and higher reliability compared with the traditional locking mechanism.

Preferably, the locking mechanism includes a rotatable insert member and a limiting member, and the rotatable insert member and the limiting member are respectively arranged on the bracket and the battery pack. By driving the rotatable insert member to rotate, the rotatable insert member is limited by the limiting member.

Through the above structural arrangement, the locking mechanism realizes the function of locking and unlocking the position between the battery pack and the bracket by utilizing the rotation of the rotatable insert member relative to the limiting member.

Preferably, an electrical connector is provided on the contact surface of the battery pack and the bracket, and the electrical connector comprises a battery end electrical connector located on the contact surface of the battery pack and a vehicle end electrical connector on a contact surface of the bracket;

the rotatable insert member and the limiting member are respectively arranged on the contact surface of the bracket and the contact surface of the battery pack.

With this structural arrangement, the position of the battery pack and the bracket can be locked by the locking mechanism, thereby improving the plugging state of the adjacent electrical connectors, thereby improving the electrical connection reliability of the battery pack.

Preferably, when the battery end electrical connector engages with the vehicle end electrical connector, the rotatable insert member rotates and is limited by the limiting member, so as to prevent the situation that the electrical connector is not plugged in place, after the position between the battery pack and the bracket is locked.

Preferably, when the battery end electrical connector engages with the vehicle end electrical connector, the locking mechanism can apply a pulling force to the limiting member along an engaging direction of the electrical connector, so that the battery pack and the bracket can be further attached closely to each other through the pulling force, thereby ensuring that the electrical connector is plugged in place.

Preferably, the locking mechanism applies the pulling force to the limiting member through the rotation of the rotatable insert member, so as to utilize the rotating action of the rotatable insert member to simultaneously realize the two purposes of locking the battery pack and the bracket, and applying the pulling force to the battery pack and the bracket, so that the battery pack is tightly inserted on the bracket.

Preferably, when the battery end electrical connector disengages from the vehicle end electrical connector, the rotatable insert member rotates and releases the limitation applied on the limiting member, so that the battery pack can be separated from the bracket.

Preferably, when the battery end electrical connector disengages from the vehicle end electrical connector, the locking mechanism can apply a pushing force to the limiting member along the pull-out direction of the electrical connector, so as to separate the battery pack from the bracket through the pushing force and ensure a rapid separation of the electrical connector.

Preferably, the locking mechanism applies the pushing force to the limiting member through the rotation of the rotatable insert member, so as to utilize the rotating action of the rotatable insert member to simultaneously realize two purposes including unlocking the battery pack and the bracket, and applying the pushing force to the battery pack and the bracket, so that the battery pack is separated from the bracket.

Preferably, the limiting member is arranged on the contact surface of the battery pack, and the rotatable insert member is arranged on the contact surface of the bracket.

Preferably, the limiting member has an accommodating cavity, the rotatable insert member enters or exits the accommodating cavity through rotation, and the accommodating cavity can limit the rotatable insert member located in the accommodating cavity, so as to allow the rotatable insert member to enter the interior of the limiting member by means of rotational motion and achieve limitation relative to the limiting member.

Preferably, the rotatable insert member includes an insert member head and a driving part, the driving part is connected to the insert member head, and the driving part is used to drive the insert member head to rotate.

Preferably, the insert member head includes a lock head and a lock head rotation shaft, the lock head rotation shaft is arranged on the bracket, the lock head is connected to the lock head rotation shaft, and the driving part is connected to the lock head rotation shaft, so as to drive the lock head to flip up and down centered on an axis of the lock head rotation shaft, realizing a movement linkage between the flip and the rotation.

Preferably, the rotatable insert member includes at least two lock heads, the lock heads are evenly distributed at both ends of the lock head rotation shaft, and the limiting portions of the limiting member are arranged in a one-to-one correspondence with the insert member head, so as to improve extent of the fixing firmness of the locking mechanism by means of locking respectively.

Preferably, the driving part includes a link mechanism, and the link mechanism drives the lock head to turn over through a lever motion.

Preferably, the limiting member is arranged on the battery pack, and the rotatable insert member is arranged on the bracket.

The link mechanism is arranged on a lower surface of the bracket, and a pivot point of the link mechanism is positioned on a battery holder beam of the bracket.

Preferably, a limiting device is provided on a surface of the battery holder beam, and the limiting device is used to limit the lever motion of the link mechanism, so as to lock the battery pack by the locking mechanism when the lever motion of the link mechanism needs to be stopped.

Preferably, the limiting device is a positioning pin, and the positioning pin is used to limit the relative position between the link mechanism and the battery holder beam, so as to lock the lever motion of the link mechanism in this relatively simple way.

Preferably, the battery pack fixing system further includes a positioning pin insertion and extraction mechanism, and the positioning pin insertion and extraction mechanism is used for inserting and extracting the positioning pins to achieve the purpose of contact locking.

Preferably, the driving part further comprises a lifter, the lifter is located below the bracket, and the lifter pushes and/or pulls the link mechanism in a vertical direction, so as to utilize the lifter driving the lock head to turn over to achieve a larger output of locking force.

Preferably, a lifting block is provided on a lifting plane of the lifter, and the lifting block acts directly on a lower surface of the link mechanism.

Preferably, a position of the lifting block relative to the link mechanism can be changed, so as to change the action point of the lower surface of the link mechanism acted by the lifter in this way, so as to realize purpose of rotation of the lock head along a first direction or a second direction.

Preferably, the limiting member includes a limiting portion, the limiting portion has an opening and the accommodating cavity, and the opening is disposed on one side of the accommodating cavity along a direction perpendicular to an engaging direction of the electrical connector, the opening is used for the insert member head to be turned over into and out of the accommodating cavity.

Preferably, the insert member head exerts a pushing force or a pulling force on the wall of the accommodating cavity by turning over in the accommodating cavity, so that when the locking mechanism applies locking and unlocking action, a push-pull action of the battery pack within the specified range can be realized by turning over.

An installation method of a battery pack, which is used for installing the battery pack on a bracket, the bracket is provided with a locking mechanism, and the installation method of the battery pack comprises the following steps:

driving the locking mechanism to rotate to lock the battery pack on the bracket.

In the installation method of the battery pack, the battery pack is locked on the bracket by using the rotation action of the locking mechanism on the bracket, so as to achieve the purpose of fixing the battery pack to the bracket. Compared with the traditional locking mechanism, the locking process is simpler, and it has the advantages of firmer fixation and high reliability.

Preferably, driving the locking mechanism to rotate to lock the battery pack on the bracket comprises the following steps:

S1, driving the locking mechanism to rotate in a first direction, so that the locking mechanism enters a locking area of the battery pack located at a preset position of the bracket;

S2, driving the locking mechanism to rotate in a second direction to lock the battery pack on the bracket, wherein the first direction is opposite to the second direction.

By rotating the locking mechanism in different directions, the locking mechanism achieves the purpose of locking the battery pack relative to the bracket.

Preferably, step S1 further includes: controlling a battery replacement device to place the battery pack at a preset position of the bracket.

When the locking mechanism rotates in the first direction, the battery pack is placed at a preset position of the bracket, so that the subsequent locking mechanism rotates in the second direction to achieve the purpose of locking the battery pack relative to the bracket.

Preferably, the installation method of the battery pack further comprises the following steps:

S0. Controlling the lifting bracket to lift the battery pack to the height of the installation position.

Preferably, step S2 further comprises: when the locking mechanism is driven to rotate in the second direction, the locking mechanism also drives the battery pack to move in a direction towards the bracket, so that the battery pack is in a locking position while the locking mechanism rotates in the second direction, so that the battery pack can be reliably locked on the bracket after the locking mechanism rotates in the second direction.

Preferably, in step S2, the locking mechanism drives the battery pack to move in the direction towards the bracket, so that the battery pack is connected with the electrical connector of the bracket while the locking mechanism rotates in-position in the second direction.

When locking the battery pack, the locking mechanism also drives the battery pack to move toward the bracket at the same time, so that the purpose of electrically connecting the battery pack to the electrical connector of the bracket is realized by the locking mechanism. Through this movement linkage mode, the function of the locking mechanism can be improved, and the problem of difficulty in engagement of the electrical connector in the prior art can be solved.

Preferably, in step S2, the locking mechanism applies a pulling force to the locking area of the battery pack to drive the battery pack to move in a direction towards the bracket, so that the battery pack and the bracket approach to each other, and complete the connection between the battery end electrical connector of the battery pack and the vehicle end electrical connector of the bracket.

Preferably, in step S1, the battery replacement device controls the movement stroke of the battery pack in the bracket to place the battery pack at a preset position of the bracket, so that the locking mechanism can lock the battery pack on the bracket through the rotation.

Preferably, in step S1, the battery replacement device receives an in-position signal of a sensor arranged at a preset position of the bracket to place the battery pack at the preset position of the bracket, to halt the installation mechanism and start the locking mechanism to lock the battery pack on the bracket.

Preferably, the bracket also has an in-position sensor, which is used to detect and control a rotation angle of the locking mechanism, so as to stop the rotation when the locking mechanism rotates to a predetermined position, so as to realize the function of locking after battery packs being in-position.

Preferably, the bracket is also provided with a rotation limiting mechanism, the rotation limiting mechanism is used to limit the rotation angle of the locking mechanism, so as to prevent the locking mechanism from causing damage to the battery pack due to an excessive rotation angle, thus deforming the battery pack case.

A removal method of a battery pack, which is used for disassembling a battery pack from a bracket, the bracket is provided with a locking mechanism, and the removal method of the battery pack comprises the following steps:

driving the locking mechanism to rotate to unlock the battery pack on the bracket.

In the removal method of a battery pack, the battery pack is unlocked on the bracket by using the rotation action of the locking mechanism on the bracket, so as to achieve the purpose of disassembling the battery pack from the bracket. Compared with the traditional locking mechanism, the unlocking process is simpler, and it has the advantages of firmer fixation and high reliability.

Preferably, driving the locking mechanism to rotate to unlock the battery pack on the bracket includes the following steps:

S1, driving the locking mechanism to rotate in a first direction to unlock the battery pack from the bracket;

S2, driving the locking mechanism to rotate in a second direction, so that the locking mechanism is separated from a locking area of the battery pack located at a preset position of the bracket, and the first direction is opposite to the second direction.

By means of rotating the locking mechanism in different directions, the locking mechanism achieves the purpose of unlocking the battery pack relative to the bracket.

Preferably, step S2 further includes: controlling a battery replacement device to take the battery pack out of a preset position of the bracket.

When the locking mechanism rotates in the second direction, the battery pack is taken out from the preset position of the bracket at the same time, so as to prevent the locking mechanism from interfering with other parts of the battery pack in the process of the locking mechanism rotating in the second direction.

Preferably, the removal method of the battery pack further comprises the following steps:

S3, controlling a lifting bracket to lower the battery pack from a height of a removal position, so as to realize the purpose of recycling the battery pack.

Preferably, step S1 further includes: when the locking mechanism is driven to rotate in the first direction, the locking mechanism also drives the battery pack to move away from the bracket, so that the locking mechanism can move in the direction away from the bracket. When the locking mechanism rotates in-position in the first direction, the battery pack is placed in the unlocked position, so that the battery pack can be reliably pushed to the unlocked position after the locking mechanism rotates in the first direction, which is convenient for the subsequent steps of taking the battery pack out of the bracket underway.

Preferably, in step S1, the locking mechanism drives the battery pack to move away from the bracket, so that the battery pack is separated from the electrical connector of the bracket while the locking mechanism rotates in-position in the first direction.

While the battery pack is unlocked, the locking mechanism also drives the battery pack to move away from the bracket, so that the purpose of separating the battery pack from the electrical connector of the bracket is achieved by the locking mechanism. Through this movement linkage mode, the function of the locking mechanism can be improved, and the problem of difficulty in engagement and disengagement of the electrical connectors in the prior art can be solved.

Preferably, in step S1, the locking mechanism applies a pushing force to the locking area of the battery pack to drive the battery pack to move away from the bracket, to move the battery pack far away from the bracket, and complete the separation between the battery end electrical connector of the battery pack and the vehicle end electrical connector of the bracket.

Preferably, the bracket is also provided with an in-position sensor, which is used to detect and control the rotation angle of the locking mechanism, so as to stop the rotation when the locking mechanism rotates to a predetermined position, and realize the function of unlocking after battery packs being in-position.

Preferably, the bracket is also provided with a rotation limiting mechanism, the rotation limiting mechanism is used to limit the rotation angle of the locking mechanism, so as to prevent the locking mechanism from causing damage to the battery pack due to an excessive rotation angle, thus deforming the case of the battery pack.

The positive progressive effect of the present invention is:

The battery pack fixing system unlocks or locks the battery pack on the bracket by using the rotation action of the locking mechanism in different directions, so as to achieve the purpose of fixing the battery pack on the bracket, and has the advantages of firmer fixing and higher reliability compared with the traditional locking mechanism.

In the installation method and removal method of the battery pack, the battery pack is locked on or unlocked from the bracket by using the rotation action of the locking mechanism on the bracket, and then to achieve the purpose of disassembling the battery pack from the bracket or fixing the battery pack on the bracket. Compared with the traditional locking mechanism, the unlocking or locking process is simpler, and it has the advantages of firmer fixation and high reliability.

### DESCRIPTION OF DRAWINGS

FIG. 1 is a schematic structural view of a battery pack fixing system according to an embodiment of the present invention.

FIG. 2 is a schematic structural view of a bracket according to an embodiment of the present invention.

FIG. 3 is a partial detailed view of part A in FIG. 2.

FIG. 4 is a schematic structural view of a battery pack according to an embodiment of the present invention.

FIG. 5 is a partial detailed view of part B in FIG. 4.

FIG. 6 is a schematic flow chart of a battery pack installation method according to an embodiment of the present invention.

FIG. 7 is a schematic view of the movement of a locking mechanism of a battery pack installation method according to an embodiment of the present invention.

FIG. 8 is a schematic flow chart of a removal method of a battery pack according to an embodiment of the present invention.

FIG. 9 is a schematic view of the movement of a locking mechanism of a removal method of the battery pack according to an embodiment of the present invention.

FIG. 10 is a schematic structural view of the movement of a rotatable insert member of a battery pack fixing system according to an embodiment of the present invention.

### REFERENCE NUMBERS

Locking mechanism 1; rotatable insert member 11; insert member head 111, lock head 111a, lock head rotation shaft 111b; driving part 112, link mechanism 112a, rotation fulcrum 112b; limiting member 12; limiting portion 121; accommodating cavity 121a; opening 121b; battery pack 2; bracket 3, battery holder beam 31, limiting device 32; electrical connector 4, battery end electrical connector 41, vehicle end electrical connector 42; lifter 6, lifting plane 61; lifting block 7.

### DETAILED DESCRIPTION OF THE PREFERRED EMBODIMENT

The present invention is further illustrated by the following examples, but it is not limited to the scope of the examples.

As shown in FIG. 1, the present invention provides a battery pack fixing system, which includes a locking mechanism 1, and the locking mechanism 1 is arranged on contact surfaces of the battery pack 2 and the bracket 3. Specifically, the locking mechanism 1 includes a rotatable insert member 11 and a limiting member12. The rotatable insert member 11 is arranged on the bracket 3, and the limiting member12 is arranged on the battery pack 2. When the battery pack 2 is placed on the bracket 3, by driving the rotatable insert member 11 to rotate, the rotatable insert member 11 is limited or released by the limiting member 12 depending on the directions of rotation. The battery pack fixing system achieves the purpose of unlocking or locking the battery pack 2 on the bracket 3 by using the rotatable insert member 11 of the locking mechanism 1 to rotate in different directions. Compared with the traditional locking mechanism, the battery pack fixing system has the advantages of more reliable fixing and high reliability. At the same time, it is convenient for daily maintenance and management because of its simple structure.

Specifically, in this embodiment, the rotatable insert member 11 is arranged on the bracket 3, while the limiting member 12 is arranged on the battery pack 2 relatively. However, in other embodiments, the rotatable insert member 11 can also be arranged on the battery pack 2, and the limiting member 12 is correspondingly arranged on the bracket 3, so as to rotate the rotatable insert member 11 arranged on the battery pack 2, the purpose of locking and unlocking the position between the battery pack 2 and the bracket 3 is also achieved.

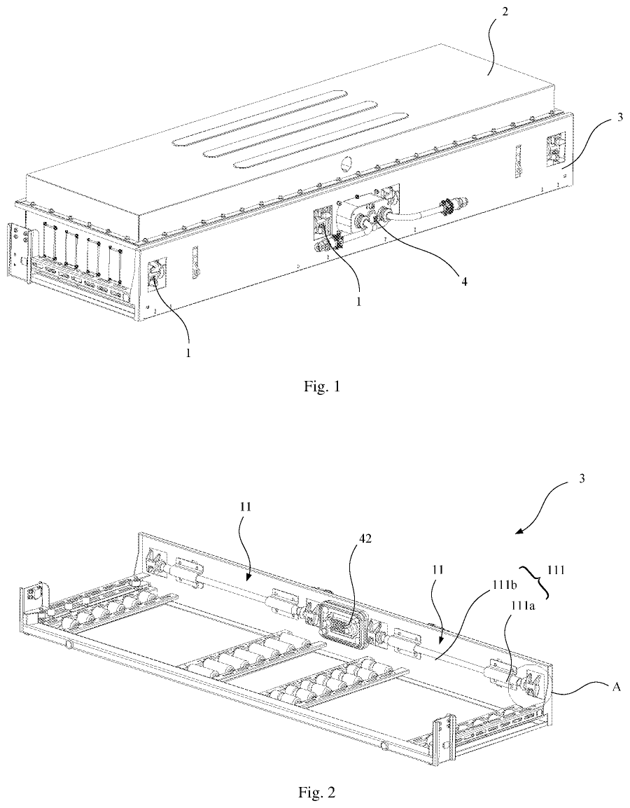

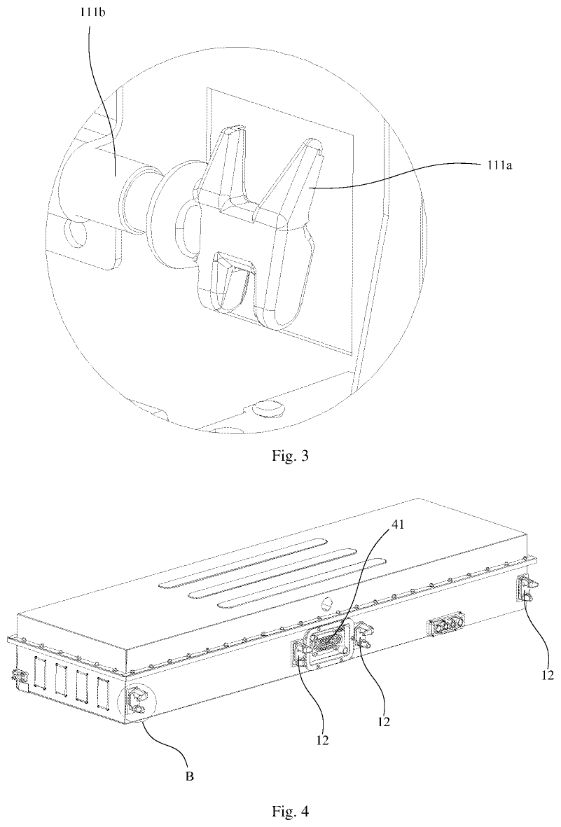

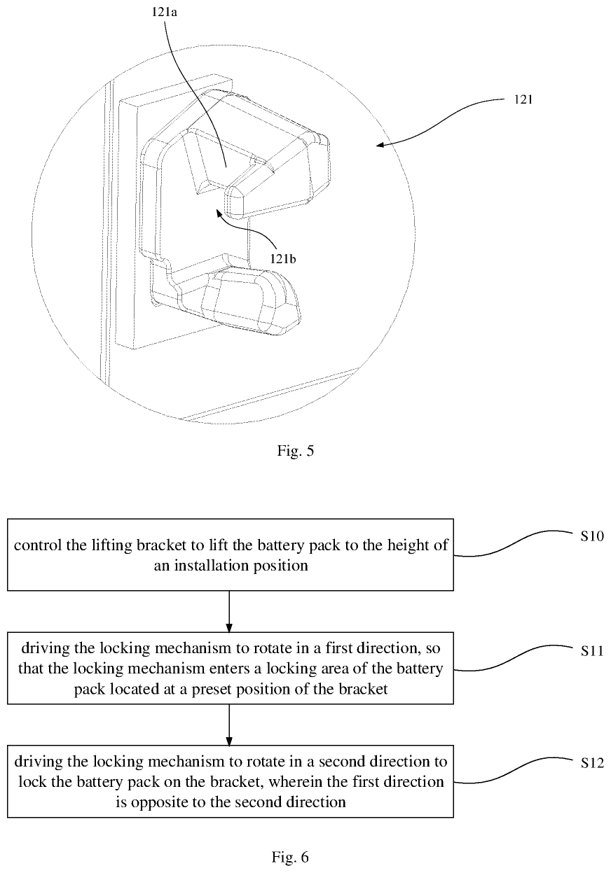

In addition, as shown in FIG. 2, FIG. 3, FIG. 4 and FIG. 5, an electrical connector 4 is provided on the contact surface of the battery pack 2 and the bracket 3, the electrical connector 4 specifically includes a battery end electrical connector 41 provided on a contact surface of the battery pack 2 and a vehicle end electrical connector 42 provided on a contact surface of the bracket 3. As for the locking mechanism 1, the rotatable insert member 11 and the limiting memberl2 are respectively arranged on the contact surface of the battery pack 2 and the contact surface of the bracket 3, that is, the locking mechanism 1 and the electrical connector 4 are arranged on the same contact surface, so as to improve the connection state of the electrical connector 4 adjacent to the locking mechanism 1 when the positions of the battery pack 2 and the bracket 3 are locked by the locking mechanism 1, and further improve the electrical connection reliability of the battery pack 2.

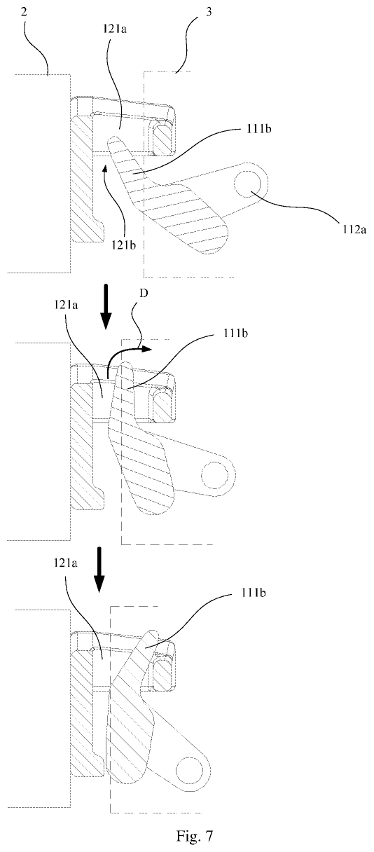

As shown in FIG. 7, when the battery end electrical connector 41 engages with the vehicle end electrical connector 42, the rotatable insert member 11 rotates and is limited by the limiting member 12, so that the position between the battery pack 2 and the bracket 3 can be locked by the locking mechanism 1 during the engagement of the electrical connector 4. Following situation is avoided: before the electrical connector 4 engage in-position, while the position between the battery pack 2 and the bracket 3 has been locked already. Further, when the battery end electrical connector 41 is engaging with the vehicle end electrical connector 42, the locking mechanism 1 can apply a pulling force to the limiting member 12 along the insertion direction of the electrical connector 4, so that the battery pack 2 and the bracket 3 can be further attached closely to each other through the pulling force, thereby ensuring that the electrical connector 4 are in engagement.

As shown in FIG. 9, when the battery end electrical connector 41 disengages from the vehicle end electrical connector 42, the rotatable insert member 11 rotates and releases the limitation applied on the limiting member 12, so that the battery pack 2 can be separated from the bracket 3. Further, when the battery end electrical connector 41 disengages from the vehicle end electrical connector 42, the locking mechanism 1 can apply a pushing force to the limiting member 12 along the disengagement direction of the electric connector 4, so as to help the battery pack 2 and the bracket 3 realize the separation of relative positions through the pushing force.

Specifically, the connection between the battery end electrical connector 41 and the vehicle-end electrical connector 42 of the electric connector 4 for vehicle batteries is usually tight, so when the battery pack 2 is installed or removed, the battery pack 2 needs to be inserted into the bracket 3 or pulled out from the bracket 3 by an external battery replacement device. During this period, the main resistance to be overcome is the inserting and pulling force of the electric connector 4. The locking mechanism 1, while physically locking or unlocking the battery pack 2 relative to the bracket 3 by rotation, can also apply a corresponding pushing or pulling force to the battery pack 2 by rotation, so as to overcome the above-mentioned inserting and pulling force of the electrical connector 4, to achieve the purpose of quick disassembly and assembly of the battery pack 2.

At the same time, since the locking mechanism 1 is arranged on the contact surface of the battery pack 2 and the bracket 3, the force exerted by the locking mechanism 1 on the battery pack 2 can be directly transmitted to the electrical connector 4 located on the contact surface, thus avoiding the deformation of the case of the battery pack 2 caused by excessive or uneven force when the traditional external battery replacement device pushes in or pulls out of the battery pack 2.

The rotatable insert member 11 includes an insert member head 111 and a driving part 112. The driving part 112 is connected with the insert member head 111, and the driving part 112 is used for driving the insert member head 111 to rotate.

The limiting member 12 has an accommodating cavity 121a, and the insert member head 111 of the rotatable insert member 11 enters or leaves the accommodating cavity 121a in a rotational manner under the driving of the driving part 112. When locking is required, the insert member head 111 rotates clockwise to enter the accommodating cavity 121a, and then the rotatable insert member 111 abuts against the inner wall of the accommodating cavity 121a to achieve a physical limit of the accommodating cavity 121a relative to the rotatable insert member 11.

Specifically, the insert member head 111 includes two parts: a lock head 111a and a lock head rotation shaft 111b. The lock head rotation shaft 111b is arranged on the bracket 3, and the lock head 111a is connected to the lock head rotation shaft 111b. The lock head 111a is the part where the insert member head 111 directly enters the accommodating cavity 121a, and the driving part 112 is connected to the lock head rotation shaft 111b, and drives the lock head 111a to turn up and down along the center of the axis of the lock head rotation shaft 111b to achieve the purpose of linked rotation.

Wherein, as shown in FIG. 3, the lock head rotation shaft 111b is connected to the middle position of the lock head 111a, and the lock head 111a includes a first insertion part located at the upper part and a second insertion part located at the lower part. As shown in FIG. 7, the first insertion portion rotates toward the battery pack to pass the accommodating cavity 121a in the limiting member 12 through the opening 121b. Then, the first insertion part rotates in the direction away from the battery pack, so that the first insertion part is limited by the limiting member 12. Similarly, the limiting member 12 includes the first insertion part located at the end of the opening 121a and having a locking function for locking the first insertion part of the lock head 111a.

Meanwhile, the limiting member 12 includes a limiting portion 121, the limiting portion 121 has an opening 121b and the above-mentioned accommodating cavity 121a, and the opening 121b is arranged at the lower side of the accommodating cavity 121a along a direction perpendicular to the engaging direction of the electrical connector 4, the opening 121b is used for the insert member head 111 to enter and exit the accommodating cavity 121a by turning over. Further, when the insert member head 111 is turned over in the accommodating cavity 121a, the insert member head 111 can apply a pushing or pulling force to the wall of the accommodating cavity 121a, so as to realize the push-pull action of the battery pack 2 within the specified forming range through the turning motion while locking and unlocking.

The present invention also provides a method for installing the battery pack 2 on the bracket 3. As the schematic flow chart shown in FIGS. 6 and 7, in this embodiment, by driving the locking mechanism 1 to rotate, the rotatable insert member 11 is moved relative to the limiting member 12 to lock the battery pack 2 on the bracket 3. Specifically, the locking process of the locking mechanism 1 includes two steps S11 and S12: first, in step S1, the battery pack 2 needs to be placed at the preset position of the bracket 3 by an external battery replacement device. In this embodiment, the preset position is actually a position where the contact surfaces of the battery pack 2 and the bracket 3 are separated by 10 cm, that is, the battery end electrical connector 41 and the vehicle end electrical connector 42 move closer to each other, but not engaging with each other. At the same time, the lock head 111a of the rotatable insert member 11 is driven to rotate in the counterclockwise direction (ie, the first direction C) to avoid interference between the lock head 111a and the limiting portion 121 of the limiting member 12, and at the same time, the lock head 111a is rotated to the position of the opening 121b of the limiting portion 121.

Thereafter, in step S12, the lock head 111a of the rotatable insert member 11 is driven to rotate in the clockwise direction (i.e., the second direction D), so that the lock head 111a enters the accommodating cavity 121a from the opening 121b and finally abuts against the inner wall surface of the accommodating cavity 121a. On this basis, through the further rotation of the lock head 111a, the lock head 111a applies a pushing force to the inner wall surface of the accommodating cavity 121a, so that the locking mechanism 1 applies a pulling force to the locking area of the battery pack 2 through the transmission of force, and drives the battery pack 2 to move toward the direction close to the bracket 3, so that the contact surfaces of the two are in contact, and the engagement of the battery end electrical connector 41 and the vehicle end electrical connector 42 is completed. Alternatively, during the rotation of the lock head 111a in the clockwise direction (i.e., the second direction D), the battery pack can be pushed toward the bracket by an external force, so that the lock head 111a does not exert any force on the accommodating cavity 121a during the rotation.

In addition, the above-mentioned method for installing the battery pack 2 on the bracket 3 may further include step S10, which is before the external battery replacement device pushes the battery pack 2 horizontally to the preset position of the bracket 3, the battery pack 2 is placed on the lifting bracket 3 first, then control the lifting bracket 3 to lift the battery pack 2 to the height of the installation position.

In this embodiment, the locking mechanism 1 acts on the locking area of the battery pack 2, so that its moving stroke matches the engaging stroke of the electrical connector 4. Here, the stroke matching specifically means that when the locking mechanism 1 locks the battery pack 2 in-position, the engagement of the electrical connector 4 is completed. Therefore, before that, the battery pack 2 must be horizontally pushed to the preset position of the bracket 3 by an external battery replacement device so that the locking mechanism 1 can function.

In order to enable the above-mentioned battery replacement device to accurately place the battery pack 2 in the preset position, a sensor should also be set at the preset position of the bracket 3. When the battery reaches the preset position, the sensor sends an in-position signal to make the battery replacement device stop working and the locking mechanism 1 start to work.

Preferably, an in-position sensor (not shown in the figures) is also provided on the bracket 3, and the in-position sensor is used to detect and control the rotation angle of the locking mechanism 1, so that when the lock head 111a of the locking mechanism 1 rotates to a certain degree, the lock head 111a stops turning when it rotates to a predetermined position to realize the function of locking in-position. In addition, in order to avoid the failure of the in-position sensor or the excessive rotation angle of the lock head 111a of the locking mechanism 1, a limiting mechanism for limiting the rotation should also be provided on the bracket 3, and the mechanism can be a block to achieve the purpose of physical limit, so that the rotation angle of the lock head 111a of the rotation limiting mechanism will not be too large, to avoid damage to the locking area of the battery pack 2 and deformation of the case of the battery pack 2.

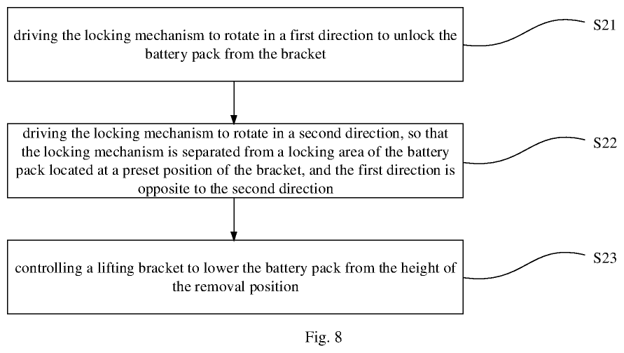

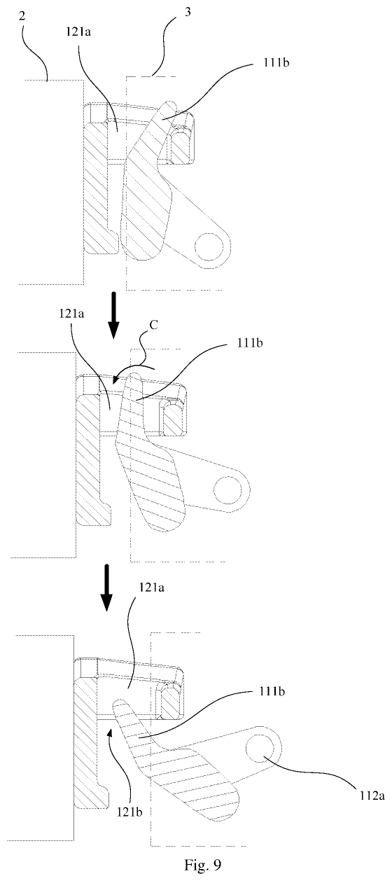

In addition, the present invention also provides a method for removing the battery pack 2 from the bracket 3. This method is used to remove the battery pack 2 installed on the bracket 3 from the bracket 3. As the schematic flow chart shown in FIGS. 8 and 9, in this embodiment, by driving the locking mechanism 1 to rotate, the rotatable insert member 11 is moved relative to the limiting member 12 to unlock the battery pack 2 relative to the bracket 3. Similar to the above-mentioned method of installing the battery pack 2 on the bracket 3, during the unlocking process of this unlocking method, the locking mechanism 1 will apply a pushing force to the locking area of the battery pack 2 to synchronously realize the purpose of disengagement between the battery end electrical connector 41 and the vehicle end electrical connectors 42.

Specifically, the unlocking process of the locking mechanism 1 includes two steps S21 and S22. First, in step S21, the lock head 111a of the locking mechanism 1 is driven to rotate in the counterclockwise direction (the first direction C) so that the lock head 111a moves toward the opening 121b, and during this process, the lock head 111a abuts against the inner wall surface of the accommodating cavity 121a. On this basis, by further rotating the lock head 111a, the lock head 111a exerts a pushing force on the inner wall surface of the accommodating cavity 121a, so that the locking mechanism 1 exerts a pushing force on the locking area of the battery pack 2 through force transmission, and drives the battery pack 2 to move away from the bracket 3, so that the contact surfaces of the two are moved away from each other, then the battery end electrical connector 41 and the vehicle end electrical connector 42 disengage from each other. At the same time, when the lock head 111a pushes the battery pack 2 to move by rotating, after the displacement of the battery pack 2, the lock head 111a can leave the accommodating cavity 121a from the opening 121b, and after leaving the accommodating cavity 121a, the locking mechanism 1 stops exerting a pushing force on the locking area, and the locking mechanism 1 also enables the battery pack 2 to be unlocked relative to the bracket 3. Specifically, when the locking mechanism 1 stops applying a pushing force to the battery pack 2 to stop the movement of the battery pack 2, the position of the battery pack 2 on the bracket 3 should be at a preset position. Or during the counterclockwise rotation of the lock head 111a, the battery pack 2 is pulled away from the bracket 3 by external force, that is, the locking mechanism 1 does not exert any force on the battery pack 2 during the rotation.

Thereafter, in step S22, the locking mechanism 1 is driven to rotate clockwise (the second direction D), so that the locking head 111a of the locking mechanism 1 is separated from the locking area of the battery pack 2 located at the preset position of the bracket 3. At the same time, the external battery replacement device should take the battery pack 2 out of the preset position of the bracket 3. The purpose of removing the battery pack 2 is achieved.

Similar to the above-mentioned installation method of the battery pack 2, the removal method of the battery pack 2 may further include step S23, which is to horizontally remove the battery pack 2 from the preset position of the bracket 3 in the external battery replacement device After being taken out, the battery pack 2 is placed on the lifting bracket, and the lifting bracket is controlled to lower the battery pack 2 from the height of the installation position, so as to achieve the purpose of recycling the battery pack 2.

In addition, the in-position sensor and the rotation limiting mechanism that play a role in the installation method of the battery pack 2 can also play the same role in the removal method of the battery pack 2, so they will not be repeated here.

In this embodiment, the locking mechanism 1 needs to place the battery pack 2 at the preset position of the bracket 3 by an external battery replacement device before it can pull the battery pack 2 to displace and implement the locking process. The battery replacement device is an existing product, so its specific structure and principle will not be repeated.

In addition, in this embodiment, a single rotatable insert member 11 includes two lock heads 111a, which are respectively arranged at both ends of the lock head rotating shaft 111b, correspondingly, the amount of the limiting members 12 is the same as that of the lock heads 111a, and they are arranged in one-to-one correspondence, so as to improve the fixing firmness of the locking mechanism 1 by locking them respectively. Meanwhile, as shown in FIG. 3, two groups of relatively independent locking mechanisms 1 are respectively arranged on the left and right sides of the bracket 3 to jointly fix the battery pack 2 and exert force on the electrical connector 4 located between the two groups of locking mechanisms 1.

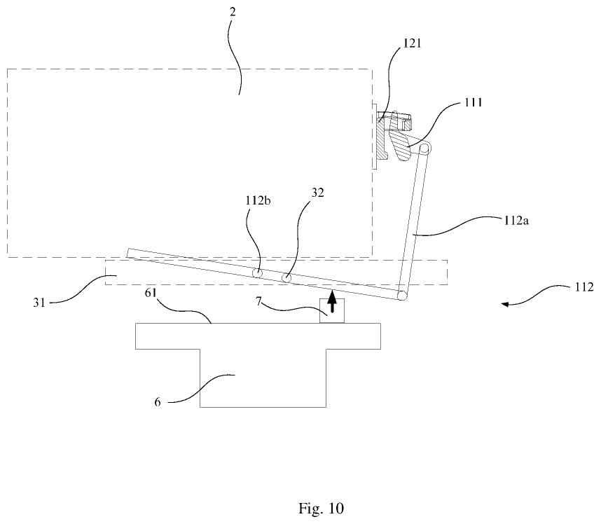

As shown in FIG. 10, the driving part 112 includes a link mechanism 112a, and the link mechanism 112a drives the lock head rotating shaft 111b to rotate through lever motion, thereby realizing the overturning of the lock head 111a. The specific principle of the link mechanism 112a is not described here because it belongs to the prior art Wherein, since the rotatable insert member 11 in this embodiment is arranged on the bracket 3, therefore the link mechanism 112a is arranged at the position of the lower surface of the bracket 3, and the pivot point 112b of the link mechanism 112a is positioned on the battery holder beam 31 in the lower half of the bracket 3 and below the battery pack 2.

A limiting device 32 is provided on the surface of the battery holder beam 31, and the limiting device 32 is used to limit the lever motion of the link mechanism 112a, so as to play a role when the lever motion of the link mechanism 112a needs to be stopped to realize the locking mechanism 1 to lock the battery pack 2. In this embodiment, the limiting device 32 uses pin positioning to achieve the limiting position. When the link mechanism 112a drives the lock head 111a to move to the position where the battery pack 2 is locked on the bracket 3, the lever of the link mechanism 112a is locked at a predetermined position of the battery holder beam 31 by the positioning pin, so as to achieve the purpose of locking the lever motion of the link mechanism 112a in this relatively simple way.

The battery pack fixing system also includes a positioning pin insertion and extraction mechanism(not shown in the figure), whose function is to pull out the positioning pin from the link mechanism 112a and the battery holder beam 31 to achieve the purpose of contact locking.

In addition, as to how the link mechanism 112a of the locking mechanism 1 generates a lever motion to realize the overturning of the lock head 111a, a relatively simple implementation is provided in this embodiment.

In this embodiment, the driving part 112 further includes a lifter 6, which is arranged below the bracket 3. When the lifter 6 pushes upward, its lifting plane 61 pushes the lower surface of the link mechanism 112a along the vertical direction, so that the link mechanism 112a turns over relative to its pivot point 112b. Under the action of this turning motion, the link mechanism 112a further drives the lock head 111a in the first direction C or the second direction D to rotate to achieve the purpose of unlocking and locking.

In order to make the lock head 111a rotate in the completely opposite first direction C or second direction D, if the lifter 6 presses against the lower surface of the link mechanism 112a to push the link mechanism 112a to turn over, the lifter 6 and the link mechanism 112a must be located on both sides of the rotation fulcrum 112b, respectively. In this case, the lifting plane 61 of the lifter 6 is provided with a movable lifting block 7. By moving the lifting block 7, change the action point of the lifter 6 acting on the lower surface of the link mechanism 112a, so as to achieve the purpose of the lock head 111a rotating in the first direction C or the second direction D.

Of course, in other embodiments, the lifter 6 can also remain connected to the same position on the link mechanism 112a, so as to drive the lock head 111a to rotate in the first direction C or the second direction D by applying a pushing force upward or a pulling force downward, respectively. In addition, preferably, the positioning pin insertion and extraction mechanism can also be arranged on the lifting plane 61 of the lifter 6, so as to drive the insertion and extraction mechanism of the positioning pin close to the link mechanism112a and the positioning pin while the lifter 6 is working.

Although the specific embodiments of the present invention have been described above, those skilled in the art should understand that this is only an example, and the scope of protection of the present invention is defined by the appended claims. Those skilled in the art can make various changes or modifications to these embodiments without departing from the principle and essence of the present invention, but these changes and modifications all fall within the scope of protection of the present invention.

1. A battery pack fixing system, wherein the system comprises a locking mechanism, the locking mechanism is arranged on contact surfaces of a battery pack and a bracket, and the battery pack is unlocked from or locked on the bracket by rotating the locking mechanism.

2. The battery pack fixing system according to claim 1, wherein the locking mechanism includes a rotatable insert member and a limiting member, and the rotatable insert member and the limiting member are respectively arranged on the bracket and the battery pack, by driving the rotatable insert member to rotate, the rotatable insert member is limited by the limiting member;
preferably, an electrical connector is provided on the contact surface of the battery pack and the bracket, and the electrical connector comprises a battery end electrical connector located on the contact surface of the battery pack and a vehicle end electrical connector on a contact surface of the bracket;
the rotatable insert member and the limiting member are respectively arranged on the contact surface of the bracket and the contact surface of the battery pack.

3. The battery pack fixing system according to claim 2, wherein when the battery end electrical connector engages with the vehicle end electrical connector, the rotatable insert member rotates and is limited by the limiting member;
preferably, when the battery end electrical connector engages with the vehicle end electrical connector, the locking mechanism can apply a pulling force to the limiting member along an engaging direction of the electrical connector;
preferably, the locking mechanism applies the pulling force to the limiting member through a rotation of the rotatable insert member.

4. The battery pack fixing system according to claim 2, wherein when the battery end electrical connector disengages from the vehicle end electrical connector, the rotatable insert member rotates and releases a limitation applied on the limiting member;
preferably, when the battery end electrical connector disengages from the vehicle end electrical connector, the locking mechanism can apply a pushing force to the limiting member along a disengaging direction of the electrical connector;
preferably, the locking mechanism applies the pushing force to the limiting member through a rotation of the rotatable insert member.

5. The battery pack fixing system according to claim 2, wherein the limiting member is arranged on the contact surface of the battery pack, and the rotatable insert member is arranged on the contact surface of the bracket.

6. The battery pack fixing system according to claim 2, wherein the limiting member has an accommodating cavity, and the rotatable insert member enters or exits the accommodating cavity by rotating, and the accommodating cavity can limit the position of the rotatable insert member located in the accommodating cavity;
preferably, the rotatable insert member includes an insert member head and a driving part, the driving part is connected to the insert member head, and the driving part is used to drive the insert member head to rotate;
preferably, the insert member head includes a lock head and an lock head rotation shaft, the lock head rotation shaft is arranged on the bracket, the lock head is connected to the lock head rotation shaft, and the driving part is connected to the lock head rotation shaft, so as to drive the lock head to flip up and down centered on an axis of the lock head rotation shaft.

7. The battery pack fixing system according to claim 6, wherein the rotatable insert member includes at least two lock heads, the lock heads are evenly distributed at both ends of the lock head rotation shaft, and the limiting member are arranged in a one-to-one correspondence with the insert member head;
and/or, the driving part includes a link mechanism, and the link mechanism drives the lock head to turn over through a lever motion.

8. The battery pack fixing system according to claim 7, wherein the limiting member is arranged on the battery pack, and the rotatable insert member is arranged on the bracket;
the link mechanism is arranged on a lower surface of the bracket, and a pivot point of the link mechanism is positioned on a battery holder beam of the bracket;
preferably, a limiting device is provided on a surface of the battery holder beam, and the limiting device is used to limit the lever motion of the link mechanism;
preferably, the limiting device is a positioning pin, and the positioning pin is used to limit the relative position between the link mechanism and the battery holder beam;
preferably, the battery pack fixing system further includes a positioning pin insertion and extraction mechanism, and the positioning pin insertion and extraction mechanism is used for inserting and extracting the positioning pins.

9. The battery pack fixing system according to claim 8, wherein the driving part further comprises a lifter, the lifter is located below the bracket, and the lifter pushes and/or pulls the link mechanism in a vertical direction;
preferably, a lifting block is provided on a lifting plane of the lifter, and the lifting block acts directly on a lower surface of the link mechanism;
preferably, a position of the lifting block relative to the link mechanism can be changed.

10. The battery pack fixing system according to claim 6, wherein the limiting member includes a limiting portion, the limiting portion has an opening and the accommodating cavity, and the opening is disposed on one side of the accommodating cavity along a direction perpendicular to an engaging direction of the electrical connector, the opening is used for the insert member head to be turned over into and out of the accommodating cavity;
preferably, the insert member head exerts a pushing force or a pulling force on the wall of the accommodating cavity by turning over in the accommodating cavity.

11. An installation method of a battery pack, for installing a battery pack on a bracket, wherein the bracket is provided with a locking mechanism, and the installation method of the battery pack comprises the following steps:
driving the locking mechanism to rotate to lock the battery pack on the bracket.

12. The installation method of the battery pack according to claim 11, wherein driving the locking mechanism to rotate to lock the battery pack on the bracket comprises the following steps:
S1, driving the locking mechanism to rotate in a first direction, so that the locking mechanism enters a locking area of the battery pack located at a preset position of the bracket;
S2, driving the locking mechanism to rotate in a second direction to lock the battery pack on the bracket, wherein the first direction is opposite to the second direction;
preferably, step S1 further includes: controlling a battery replacement device to place the battery pack at the preset position of the bracket;
preferably, the installation method of the battery pack further comprises the following steps:
S0. Controlling the lifting bracket to lift the battery pack to the height of an installation position.

13. The installation method of the battery pack according to claim 11, wherein step S2 further comprises: when the locking mechanism is driven to rotate in a second direction, the locking mechanism also drives the battery pack to move in a direction towards the bracket, so that the battery pack is in a locking position while the locking mechanism rotates in the second direction.

14. The installation method of the battery pack according to claim 13, wherein in step S2, the locking mechanism drives the battery pack to move in the direction close to the bracket, so that the battery pack engages with the electrical connector of the bracket while the locking mechanism rotates in-position in the second direction;
and/or, in step S2, the locking mechanism applies a pulling force to the locking area of the battery pack to drive the battery pack to move in the direction towards the bracket.

15. The installation method of the battery pack according to claim 12, wherein in step S1, the battery replacement device controls the movement stroke of the battery pack in the bracket to place the battery pack at the preset position of the bracket;
and/or, in step S1, the battery replacement device receives the in-position signal of a sensor arranged at a preset position of the bracket to place the battery pack at the preset position of the bracket.

16. The installation method of the battery pack according to claim 12, wherein the bracket is further provided with an in-position sensor, which is used to detect and control a rotation angle of the locking mechanism;
and/or, the bracket is also provided with a rotation limiting mechanism, the rotation limiting mechanism is used to limit the rotation angle of the locking mechanism.

17. A removal method of a battery pack, for disassembling a battery pack from a bracket, wherein the bracket is provided with a locking mechanism, and the removal method of the battery pack comprises the following steps:
driving the locking mechanism to rotate to unlock the battery pack on the bracket.

18. The removal method of the battery pack according to claim 17, wherein driving the locking mechanism to rotate to lock the battery pack on the bracket, comprises the following steps:
S1, driving the locking mechanism to rotate in a first direction to unlock the battery pack from the bracket;
S2, driving the locking mechanism to rotate in a second direction, so that the locking mechanism is separated from a locking area of the battery pack located at a preset position of the bracket, and the first direction is opposite to the second direction;
preferably, step S2 further includes: controlling the battery replacement device to take the battery pack out of the preset position of the bracket;
preferably, the removal method of the battery pack further comprises the following steps:
S3, controlling a lifting bracket to lower the battery pack from a height of a removal position.

19. The removal method of the battery pack according to claim 18, wherein step S1 further comprises: when the locking mechanism is driven to rotate in the first direction, the locking mechanism also drives the battery pack to move in a direction away from the bracket, so that the battery pack is in the unlocking position after the locking mechanism rotates in-position in the first direction;
preferably, in step S1, the locking mechanism drives the battery pack to move away from the bracket, so that the battery pack is separated from the electrical connector of the bracket after the locking mechanism rotates in-position in the first direction;
and/or, in step S1, the locking mechanism applies a pushing force to the locking area of the battery pack to drive the battery pack to move in a direction away from the bracket.

20. The removal method of the battery pack according to claim 18, wherein the bracket is further provided with an in-position sensor, and the in-position sensor is used to detect and control a rotation angle of the locking mechanism;
and/or, the bracket is also provided with a rotation limiting mechanism, the rotation limiting mechanism is used to limit a rotation angle of the locking mechanism.
